(19) United States
(12) Patent Application Publication
(10) Pub. No.: US 2012/0097011 A1
(43) Pub. Date: Apr. 26, 2012

(54) Pedal-Controlled Drumstick Device ˜ The Leopold Drumstick

(76) Inventor: Ari Leopold, (US)

(21) Appl. No.: 12/815,470

(22) Filed: Oct. 25, 2010

(51) Int. Cl. G10D 13/02

(52) U.S. Cl. 84/422.4

(57) ABSTRACT

This musical instrument assembly enables the user to control a percussive mallet with a foot-pedal. It operates by a cable threaded around the circumference of a wheel with attached mallet, the other cable end connects to the pedal. Cable housing and mounted fixtures at the entrance and exit of this housing provide a fixed path for the cable to move back and forth. Springs return the invention to its original position upon pedal's release. Flexible housing enables remote capability, equal function without requiring particular angle or distance between the pedal and beater assemblies. Mounting the mallet off either side of the wheel results in either downward or upward motion.

### BRIEF DESCRIPTION OF THE DRAWINGS

FIG. 1 is a side-view drawing of the whole invention.

FIG. 2 is crosshatch view of the whole invention.

FIG. 3 is an exploded view of the beater assembly.

FIG. 4 is a reproduction of FIG. 1, but with the drumstick reverse-mounted so as to show the equal reverse-function of the invention.

### BACKGROUND OF THE INVENTION

There are very few musical instrument assemblies that connect a footpedal to a drumstick/percussive mallet. This invention uses the motion of a cable and wheel to accomplish this task. This unique and simple mechanism results in a combination of features which may make the present invention highly preferable to the user, over other inventions that have been devised for this task. Using a cable and wheel to accomplish the task results in a very particular and precise control (“action”) that the user can exert over the drumstick by means of activating the pedal, which may be preferable to the user.

The invention also has various features that facilitate the ease of its installation and use. First of all, a practical embodiment is considerably small—our working embodiments link a standard drumstick to a typical-sized footpedal, and the resulting invention is lightweight enough so that a person of average size can easily carry many of them at once. (This can be a very significant factor to musicians who travel and/or perform.) The compact beater assembly can unobtrusively be mounted on or near its percussion instrument using a standard typical percussion stand, and can be positioned or repositioned in moments. Due to the flexibility of the cable and housing, the invention possesses a remote capability, whereby the drumstick/beater assembly can be easily mounted in the ideal position to strike its designated instrument, while the pedal can control it from anywhere within the range of the cable housing. The user also has the opportunity to remount the drumstick for equally effective function in the opposite direction.

This invention can be built in a variety of scales, thus allowing the user to choose the embodiment that is most preferable. Different sized wheels result in different action. Different lengths of cable and housing can be used, and there is no theoretical limit on the maximum length. Additionally, the mounting ties holding the drumstick to the wheel can be loosened to result in double or multi-strokes from the drumstick with each press of the pedal. The opportunity to make these choices is extremely relevant to the user for musical applications. Also, the practical embodiment of this invention is small and simple enough that it could affordably be reproduced in quantity and marketed.

### BRIEF DESCRIPTION OF THE INVENTION

The common application envisioned for this invention is as a musical instrument assembly. The invention allows the user to control a drumstick or other percussive mallet with a foot-pedal, presumably to play a percussion instrument. It operates by means of a cable threaded around the circumference of a wheel with attached mallet, while the other end of the cable is connected to a pedal, which the user activates, presumably with his/her foot. A cable housing and mounted fixtures at the entrance and exit of this housing provide a fixed path for the cable to move back and forth. Springs return the invention to its original position when the user releases the pedal. The cable and housing are flexible, so that the invention's function does not require any particular spatial relationship between pedal and the beater assembly (which contains the wheel/drumstick) either in angle or distance. Therefore, within the length of the cable housing, the pedal has remote control over the mallet. The mallet can be mounted facing off either side of the wheel, resulting in either downward or upward motion.

### FULL DESCRIPTION OF THE INVENTION

The drumstick 1 is attached to a wheel 2. The preferred embodiment of the wheel includes a rotary bearing at its center. The wheel is attached to one end 3a of a drive cable 3, and the cable's other end 3b is attached to the pedal's stomping plate 4. When the user depresses with his/her foot, the end of the plate pulls the cable, in turn causing the wheel to turn and the drumstick to move. These parts comprise a continuous unit, which moves in reference to the remaining stationary parts.

The invention is comprised of two subassemblies, the beater assembly and the pedal assembly, and cable 3 runs through the inside of a tubular housing 5, linking the subassemblies.

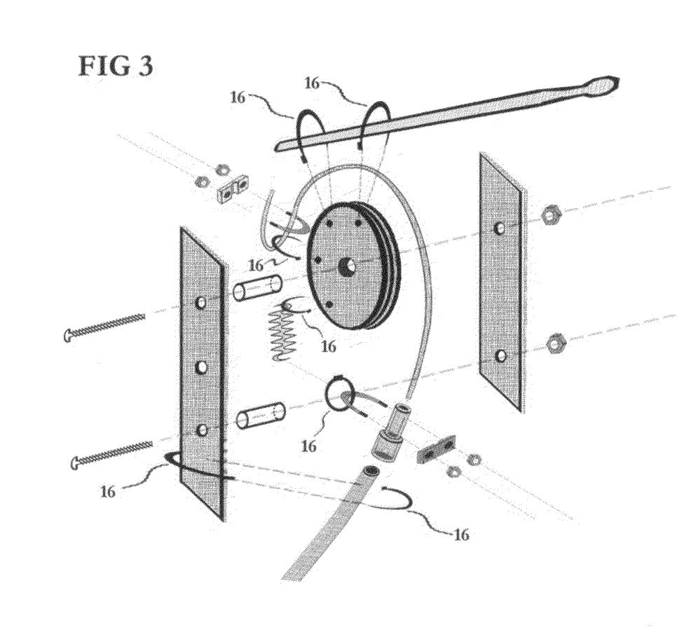

The beater assembly includes a chassis 6, on which the wheel 2 is mounted so that it may turn freely. The primary spring 7, and the drive cable exit mount 8 are also fixed to the chassis. The drive cable exit mount holds the end of the cable housing 5 stationary while allowing the cable end 3a to pass back and forth freely through it. The other end of the primary spring 7 is fixed to the back of the wheel 2. The drive cable exits the housing through the exit mount, and threads around the perimeter of the wheel from the front. The cable end 3a is attached to the wheel 2. The wheel is of the shape used in a pulley, with a shallower track in the center of its perimeter as shown in FIG. 3, which keeps the drive cable from sliding off edge of the wheel. When the user releases the pedal, the primary spring pulls the wheel and drumstick back to the original position.

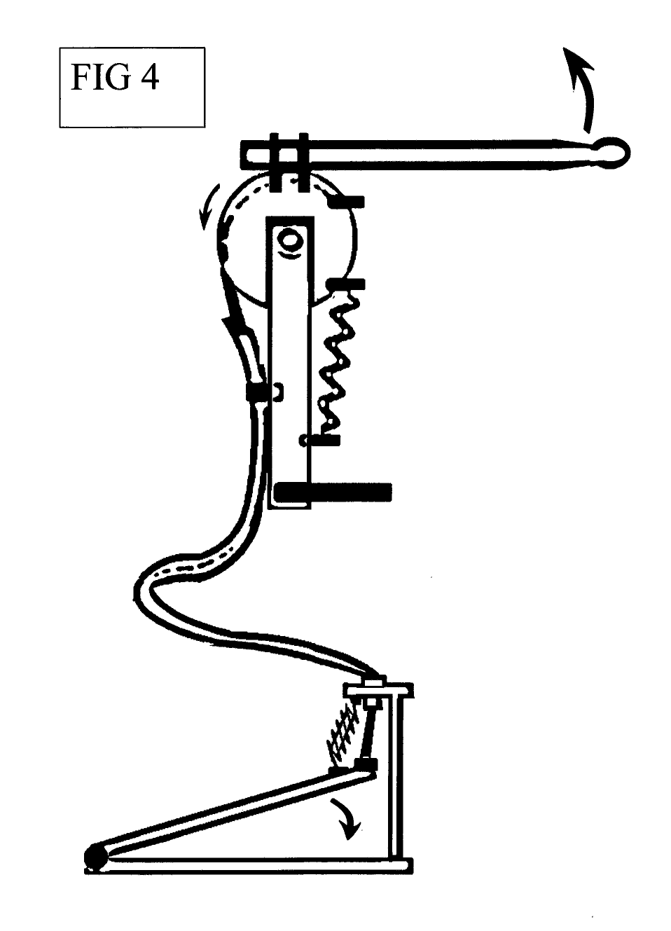

When the drumstick is mounted on the wheel sticking out in the forward direction, then a downward motion on the pedal will result in a downward motion of the drumstick. If the drumstick sticks backward off the wheel, then depressing the pedal will cause the stick to strike upward. The user can choose which direction is preferred. This is the feature of the invention characterized in claim 3, and depicted in FIG. 4.

The chassis 6 (and in turn, the whole beater assembly) is mounted to some fixed piece of apparatus by a mounting hardware attachment 10. As the invention is intended for use with percussion instruments, the user will probably use a percussion stand for a fixed apparatus, however there is an indefinite range of usable stands and mounting mechanisms. Therefore, no specific shape for hardware attachment 10 is claimed herein, nor specified beyond the requirement that hardware attachment 10 affixes the beater assembly to fixed apparatus such that the chassis 6 and cable exit mount 8 remain stationary while the invention is in use.

The pedal assembly contains a stationary base plate 9, and the drive cable entrance mount 11 is mounted above the base plate by a support structure 12. In the case of our working models, support structure 12 is comprised of two vertical posts and a flat plate across them. The entrance mount 11 is secured to and through a hole in the top plate. Cable end 3b is allowed move back and forth freely while bottom end of the housing 5 is held stationary. An indefinite number of shapes could be used for support structure 12 provided only that the support structure holds the cable entrance mount 11 stationary while the invention is in use.

The hinge 13 connects the stomping plate 4 and the base plate 9 at the heel end, and the drive cable end 3b is fixed to the toe end. This creates the mechanism whereby the user stepping on the stomping plate 4 pulls the cable end 3b through the entrance mount 11, which in turn activates the mechanism of the beater assembly as described above. The drive spring 14 pulls the stomping plate back to the initial position. Without the drive spring, the weight of the stomping plate would be supported by the cable and primary spring, causing the invention to feel different (presumably less comfortable) to the user. However, note that the drive spring is otherwise inessential to the invention's mechanism.

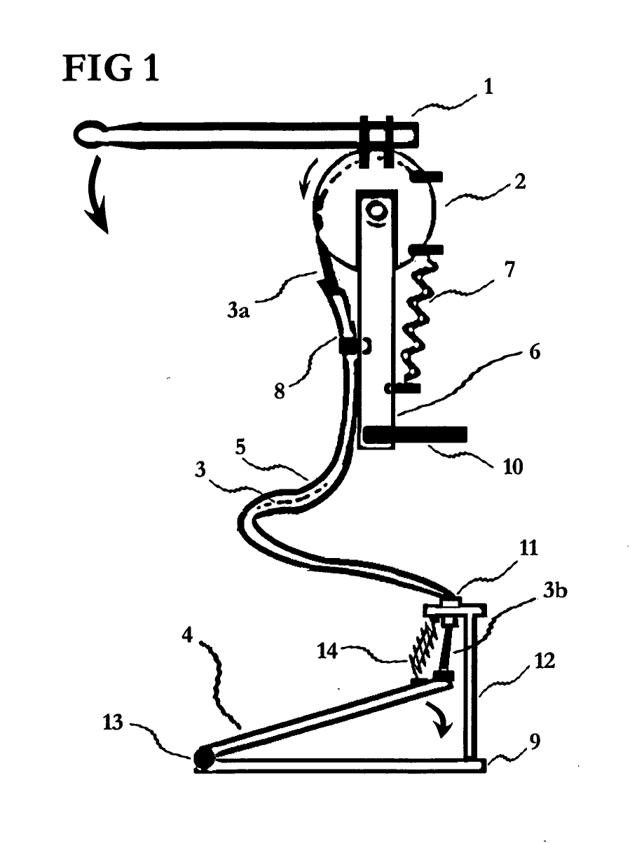

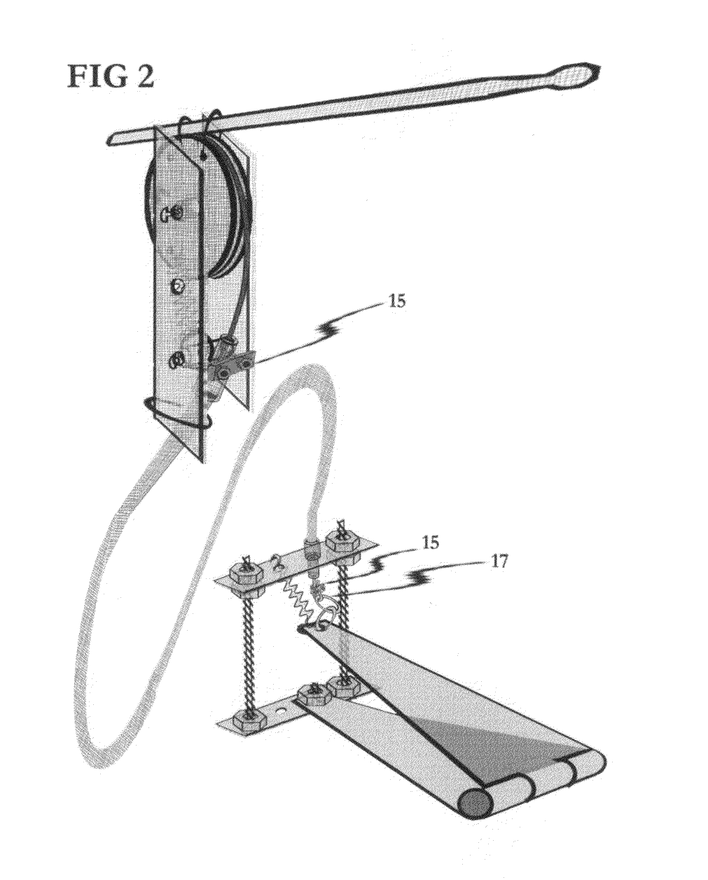

Also note that FIG. 2 and FIG. 3 depict a particular working embodiment where the base plate is made by affixing two pieces: a small plate mirroring the top plate of support structure 12, and a triangular plate mirroring the stomping plate 4. A manufactured version of the invention has a base plate that is one continuous piece (as depicted in FIG. 1 and FIG. 4,) with measurements such that the toe end of the stomping plate 4 is connected to cable end 3b directly below cable entrance mount 11, allowing the cable 3 to be pulled straight through the entrance mount 11 without being bent.

The cable housing 5 is semi-stiff. It can be curved at any point on its length, and is therefore flexible enough that the beater and pedal assemblies can each be positioned independently from each other, within the range of the cable's length. This is the feature described in claim 2 as REMOTE capability. The housing 5 is nevertheless rigid in its length, and is not subject to be compressed or stretched by the cable moving inside it. This is the essential feature of the housing that enables it to remain stationary while the cable 3 passes freely back and forth within it, thus creating the differential of motion which translates motion on the pedal's stomping plate 4 into motion on the wheel 2, and in turn the drumstick/mallet 1. A variety of available materials possess this semi-rigid quality. In our working models, we have used a tubing material where plastic and rubber surround a coil of thin metal. The invention's remote feature may be crucial in cases where the desired percussion instrument is not located near the user's foot, or where it is desired for the mallet to strike at a sideways or otherwise unusual angle.

In constructing a KickStick, a variety of materials are possible, as long as they are strong enough to withstand the pressure of the user's stomp, which will likely be between 50 and 350 pounds. Our working embodiments have been constructed from metal parts, other housing 5, which includes plastic and rubber as described above. In several places on the invention, two components are affixed to each other, and a large variety of clasps and materials could be used for this purpose. As FIG2 and FIG. 3 depict, our working embodiments utilize screw-tight clasps 15 around the cable ends 3a and 3b, which put each cable end in a loop. This method is highly effective but not essential to the function of the invention. Our working embodiments utilize a wheel with holes in it at intervals, and wire ties 16 thread through these holes. Drumstick 1, the loop of cable end 3a and the moving end of the primary spring 7 attach to the wheel 2 by means of these wire ties. As shown in FIG. 2 and FIG. 3, such clasps are used at various points throughout the invention. One or multiple chain links 17 between the loop of cable end 3b and stomping plate 4 facilitate the invention's function and durability by accommodating for slight variations in the angle between cable end 3b and stomping plate 4 which may result from the construction process. The bottom-most link 17 may be attached to stomping plate 4 by means of additional wire ties 16, or welded to stomping plate 4, or manufactured as part of stomping plate 4. Wire ties 16 may be substituted by a variety of clamps, cable-stops, zip ties, knots, or even glue—any substitute would suffice for the invention to function, requiring only that adjacent pieces adjoin with sufficient strength such as to tolerate use.

Construction of the invention can be implemented at a wide variety of size scales, provided the minimum requirements that the user is physically able to activate the pedal, the beater assembly is able to hold the stick/mallet (which itself could be any size), the springs are able to hold the forces on them, and that the cable is able to withstand the force of the user's strike. Our working embodiments are made for the presumably most practical application: use with a standard drumstick, 16-20″ in length. The user's foot, and consequently the appropriate length for the stomping plate 4 of the pedal, is likely to be 8-16″ long and 2-5″ wide. The appropriate responsiveness seems to result from a 2-4″ diameter wheel 2. However, a large bass drum beater on a wheel up to 12″ in diameter is still practical for normal use, and a wheel as small as ½″ can be used in order to accomplish a very sensitive response from the pedal. The support structure 12 functions well when it is 3-7″ tall, allowing the pedal to release to an angle between 15-45 degrees. A pedal at a more extreme angle or sideways could also be feasibly implemented. The wheel could also be attached to multiple drumsticks, potentially in both directions at once. The cable and housing can be embodied at any physically achievable length. In all these cases, the essence of the invention's function remains unchanged.

I claim:

1. The musical instrument assembly operated by a cable threaded along a wheel's circumference, which turns the wheel as it is pulled by a foot pedal, thus activating a drumstick or other percussive mallet attached to the wheel.

2. The musical instrument assembly of claim 1, wherein the cable passes through a flexible housing, thus giving the device a REMOTE feature, where the pedal and beater assembly can be positioned independently of each other, anywhere within range of the cable housing's length.

3. The musical instrument assembly of claim 1, wherein the user may choose to mount the drumstick or percussive mallet either forward or backward on the wheel, resulting in the mallet striking either downward or upward, respectively.
